(19) United States
(12) Patent Application Publication
(10) Pub. No.: US 2010/0119768 A1
(43) Pub. Date: May 13, 2010

(54) Light-weight thermoplastic olefin truss core for laminated panels for use in the transportation and RV industries

(76) Inventors: Barney Ernest Simon, Bristol, IN (US); Michael Gordon Robinson, Elkhart, IN (US)

Correspondence Address: Barney E Simon, 53245 Trenton Lane, Bristol, IN, 46507, US

(21) Appl. No.: 12/077,928

(22) Filed: Mar. 24, 2008

Related U.S. Application Data
(60) Provisional application No. 61/007,445, filed on Dec. 13, 2007.

(51) Int. Cl. B32B 3/12

(52) U.S. Cl. 428/116

(57) ABSTRACT

A lightweight thermoplastic core, formed from ThermoPlastic Olefin/ThermoPlastic Vulcanite (TPO/TPV) sheet machined. Said sheet is made of a TPO material that contains fillers to enhance strength and improve Coefficient of Linear Expansion (CLTE). The sheet is heated to thermoforming temperature, then formed by pressure-forming or mechanical pressing the desired shape (truss shape), forming a multi-dimensional core.

Said core now is several times thicker than the input sheet. The new-formed core still has sufficient surface area to provide a sufficient bond to produce a structural panel.

The core also utilizes the shape or wall formed in the Vertical Plane to create Vertical columns similar to honeycomb.

The core is of sufficient strength as to handle compressive loads on all three axes: x, y, and z.

Said core is ideal for application in the transportation and RV industries.

### RELATED APPLICATION DATA

The present invention is a continuation in part of application Ser. No. 427,496, December 1973 and Ser. No. 388,056, June 1975, Now Abandoned.

### BACKGROUND OF INVENTION

The present invention is a formed, olefinic material, used to make a lightweight core material. The present invention generally falls into the honeycomb materials group.

The present invention is an improvement on such products. Honeycombs are used as fillers in structures such as aircraft wings, and panel products because of their strength-to-weight ratio.

Structures that employ honeycomb cores can withstand tremendous weights and pressures because of the support column effect. Each cell provides support (normally vertical). When other cells are added, the ability to support these loads continues to increase. The more area the cell can occupy, the more the core will support.

Honeycombs have been used for many years. U.S. Pat. No. 2,502,304 Baker reveals, a method of making expanded plastic material. To gain strength, Baker laminated two sheets of plastic together and used a platen press to heat and expand the material.

In U.S. Pat. No. 3,011,602 Ensrud and Ochreano present an embossed (formed) core. Sheet metal is pressed into a pyramid shape with a flat top to allow the core to be bonded or welded to the top and bottom skin to produce a sandwich panel.

These types of panels are lightweight and very strong in compression and shear as well as edgewise and transverse. As a result, this type of panel is very desirable for use in the transportation industry.

In U.S. Pat. No. 3,525,663 Hale takes the approach to form a core structure by pushing rods from both top and bottom into a sheet of plastic or aluminum. The resulting core forms a web between the embossed rod nodes in each direction. This web forms an arch or truss.

Hale then discusses affixing membranes to the core to produce a sandwich-type panel. Hale achieves great strength by filling the panel with foam or other materials, a process not needed with the present invention.

A formable honeycomb panel is disclosed in U.S. Pat. No. 4,859,517 by H R Hull. Hull provides a formable panel using a honeycomb core and flexible skins or faces bonded to the core. The assembly is capable of being formed or shaped to a desired panel. The present invention is not intended to be formed, but has the ability to be formed if so desired by heating the core.

Turner introduces a multilayer honeycomb structure in U.S. Pat. No. 5,106,668. The inventor shows two layers of honeycomb core faced with fiber-reinforced resin by placing a smaller, very dense core in the first layer, then placing a skin, again fiber-reinforced resin. The second layer core is less dense and has larger structure and is skinned on the outside face with a fiber-reinforced resin.

The panel is then cured under heat and pressure. This panel is very strong and highly impact-resistant. The present invention provides similar strength and impact-resistance and does not require the second layer and third skin on the inner faces.

In U.S. Pat. No. 5,421,935 Dixon and Turner reveal a formed, fused section type of honeycomb. This method is in use today and produces high quality thermoplastic honeycomb core. The present invention does not require any fusing to produce a high strength core.

In U.S. Pat. No. 5,460,865 Teotsis discloses a hybrid honeycomb sandwich panel. He employs a two-layer honeycomb structure that uses a thin membrane to join the layers. This dual layer approach provides an improved ability to hold highly compressive loads. The present invention can hold highly compressive loads in one layer.

In U.S. Pat. No. 5,759,680 the inventors bring forth a composite that is extruded and is compressed of cellulose fiber and recycled polyethylene. Like this composite, the present invention is based on an extruded polymeric material. The present invention is an improvement, as it uses filler (working fillers) that enhances the ability to use heat very effectively to form the core.

In U.S. Pat. No. 5,804,278 Pike combines honeycomb core and plywood to produce a structural panel for use in building lightweight tables, desks and other furniture and fixtures. The present invention provides an improved core for such uses and would employ a much lighter wood surface.

In U.S. Pat. No. 5,460,864 Heithanp presents a multilayer panel that employs fire resistant skins and center layers. This combination produces a class “A” Fire Rating in transportation application.

Due to the natural burn resistance of the components and fillers of the present invention, the core is rated at class “B” and is suitable for use in many transportation applications.

In U.S. Pat. No. 6,099,680 Harris and Seifried improve the ability to bond to honeycomb cores by providing a face or veil bonded to the honeycomb. The present invention also improves the ability to be bonded to faces and does not require the face skin or veil. The present invention provides exceptional bonding due to its large bearing surface.

In U.S. Pat. Nos. 3,919,382 and 4,148,954 Walter Smarook discloses a core expanded of theromoformable material. These patents are the beginnings of the present invention. Smarook understood that he could pull a plastic sheet into an object with three dimensions and he called his product a honeycomb type core. Once the core was pulled too far, the cell walls became too thin and the walls would not support the compressive loads of the present invention.

At the time Smarook was also limited to Polystyrenes, Acrylics, and Polycarbonates for sheet materials. These products work well but are based on oil and are expensive and heavy.

The present invention is lighter and stronger based on density, and when expanded into core, is stronger per size-to-weight ratio than most other core materials.

In U.S. Pat. No. 5,102,710 Kaufman and Robinson discuss formed weatherable decorative panel. The core of that panel is rigid foam. The present invention could easily replace the rigid foam and reduce the cost and weight of that panel.

### REFERENCES CITED

U.S. PATENT DOCUMENTS

| | |
|---|---|
| U.S. Pat. No. 2,502,304 | Baker |
| U.S. Pat. No. 3,011,602 | Ensrud & Ochieano |
| U.S. Pat. No. 3,525,663 | Hale |
| U.S. Pat. No. 3,919,382 | Smarook |
| U.S. Pat. No. 4,148,954 | Smarook |
| U.S. Pat. No. 4,859,517 | Hull, H. R. |
| U.S. Pat. No. 5,102,710 | Kaufman & Robinson |
| U.S. Pat. No. 5,106,888 | Turner |
| U.S. Pat. No. 5,421,935 | Dixon |
| U.S. Pat. No. 5,460,864 | Heitkamp |
| U.S. Pat. No. 5,460,865 | Tsotsis |
| U.S. Pat. No. 5,759,680 | Brooks, et al |
| U.S. Pat. No. 5,804,278 | Pike |
| U.S. Pat. No. 6,099,680 | Harris, et al |

### THE DETAILED DESCRIPTION OF THE INVENTION AND PREFERRED EMBODIMENTS THEREOF

In the present invention is a core for use in the transportation and recreational vehicle industries. Intended for but not limited to composite panels for use in those industries.

An improvement over honeycomb and similar type of core, the present invention is formed from, but not limited to, flat sheet of proprietary TPO/TPV Olefinic material: a type of thermoplastic olefin that has been modified to include proprietary working fillers as well as highly vulcanized rubber particles, thus the reference to TPV's standing for thermal plastic Vulcanite's. This unique combination of materials is normally found in what the plastics industry calls thermal plastic elastomers or Elastomeric Alloys.

These plastics are known for their ability to flex yet remain very strong. An ideal application of such a product is a flexible car bumper. These materials are widely used in automotive applications because they can handle high impacts with little damage. These products are easy to repair and can be primered to do accept paint that matches the vehicle. Unlike molded or formed products, in the present invention relates to flat and formed panels.

The need for such panels has grown in the transportation and recreational vehicle industry over the last 20 years. Early recreational vehicles (vacation trailers) were made out of wood framing and covered with aluminum or other sheet metal materials.

The inside paneling was usually a type of plywood. While these vehicles served the industry well, they were very heavy, susceptible to leaks and water damage, and would not deal with impacts well at all. A typical stick-and-tin (as it is called) travel trailer sustains serious damage in any kind of collision.

The present invention solves several problems confronting the RV industry today. The new thermoplastic alloy core of the present invention provides a product that can withstand high impact as well as high compressive loads in all directions. The present invention also demonstrates the advantage of a truss shape over standard honeycomb type cores. The present invention can be formed all on a platen press using a stretch method. The preferred method to manufacture the core of the present invention is to thermoform the sheet into the core using triangular shaped elements to press or emboss the shape into both sides of the sheet.

FIG. 1 shows a standard honeycomb core: notice the thin wall shape of each cell. The top of each cell provides a contact or bearing surface of approximately 0.040 of an inch.

Many attempts to provide an improved bonding surface to honeycombs have been tried through the years. FIG. 2 shows a view of the present invention showing its triangular or truss shape. Notice the large bearing surface between the truss areas. It is this bearing surface combined with the unique properties of the TPO alloy material that provides strength in all directions. It is also the large bearing surface that gives the present invention its ability to bond to skins to form a composite panel of superior mechanical strength and improved physical properties.

The bearing surface of the present invention is four to five times larger than in typical honeycomb. Combined with the unique truss shape, the present invention provides superior performance in compression and the edge-wise sheer in a panel application. The trucking industry has relied on metal sides for box trucks in semi-trailers for years. A widely accepted method of building such a truck or trailer has been to join metals panels, normally aluminum, together using rivets and caulking material to ensure a waterproof side.

The present invention offers an alternative to this type of construction; a single sheet of polymer can be laminated to a combination of sheets of core material of the present invention, providing a seamless wall or panel. This provides a waterproof side for use in the transportation and RV industries. This seamless side is also desirable where graphics and lettering are applied to the sides of trailers, trucks, or recreational vehicles. Because the core of the present invention can be spliced together, it can provide a core the size of the finished wall that up until now has not been practical to build.

Cores made with the present invention can be as long as 60 feet and as high as 10 feet with no problem. Smaller cores can be used to manufacture trailer products such as cargo trailers, utility flatbed trailers, horse trailers, and other types of towable products. To date no other core product has had such utilitarian abilities.

Cargo trailers and horse trailers, as well as box trucks, derive much of their structural integrity from the sidewalls. It is the ability of the walls to move energy, both mechanical and thermal into the floor, frame, and roof structures as it moves on the highway that provides a safe vehicle. Other products based on plastics, particularly fiber reinforced polyester more commonly known in the transportation industry as FRP, have been used for years.

These FRP products while durable are having and are based on petroleum products.

The industry has seen the costs of these products increase substantially over the last 10 years. It is the objective of the present invention to help reduce cost, and weight. Further the present invention is considered green, as it is recyclable at the end out of its service life. Another desirable feature of the present invention is its ability to be combined for laminated to a variety of other products, while the outside of the panel may be a weatherable polymer, the inside surface may be but is not limited to wood paneling, plywood, vinyl covered wood, drywall or other material based on the intended end use of the vehicle.

Likewise the interior panel may also be, but is not limited to a type of polymer or plastic, and thereby provides washable interiors for the vehicle. The core of the present invention is not limited to use as a wall product, because it has the ability to handle large compressive loads, it is ideal for use as core of a floor for use in trucks, trailers, recreational vehicles, and boats.

When it is desirable to have a roof that can handle loads such as people moving about on top of a trailer or other vehicle, the present invention can provide a core for a roof structure suitable for this application. When combined with a roof bow spaced on appropriate centers, the core can be formed into an arch, as required in many transportation applications.

Materials based on olefins normally will not stick to to themselves or other materials. Likewise they resist paint and other finish treatments. For this reason, surface modification of the core is desirable to improve adhesion to allow it to be used in panels. The plastics industry has successfully used surface modification to improve adhesion and the ability to paint products for years.

Some types of surface modification are Corona treatment, surface abrasion, chemical etching, and exposure to a highly reactive gas. While all of these methods improve the ability to bond and paint these products, in some cases the surface treating is only temporary. The preferred method of surface modification for the present invention is exposure to a reactive gas. The most effective gas treatment is called Fluoro-Sealing. (Fluoro-Seal® and Inhance® are registered trademarks of Inhance/Fluoro Seal, Ltd.). Named Fluoro Seal because the highly reactive gas used is fluorine, this process gives the bearing surfaces of the present invention the ability to adhere to other TPO's, as well as unlike polymers and plastics.

Special nano adhesives can be used with the present invention; such nano adhesives may be used without surface modification in many cases. In his 2003 presentation to the Polyurethane Molders Association Dr. Bernard Bauman explains surface energy and the ability to do what is known as wetting of a surface. When a surface can be wetted, it has the ability to be glued or adhered successfully to another surface. As nano technology improves, we find that nano adhesives have natural wetting tendencies. It is these tendencies in conjunction with the present invention that allow this improved core to be laminated into panels for the RV and transportation industries.

If adhesives that do not and have these wetting tendencies are used with the present invention, then surface modification of the core insures its ability to bond. Recognized commercial adhesives such as polyurethane and acrylics, as well as epoxies and contact cements can be used successfully with the present invention when it is surface modified. One of the unique features of the present invention is its ability to work with either adhesives with natural wetting tendencies or it can be surface modified to provide the necessary wetting tendencies to work with commercially available adhesives. The following paragraph is Dr. Bauman's explanation of wetting abilities of polymer surfaces.

Most plastics and rubbers have very low surface energy. This can be illustrated by putting a drop of a high surface tension liquid like water (or polyol or prepolymer) on the surface and observing the shape of the drop. If the high surface tension liquid beads up, Figure I, it is an indication that the surface has low surface energy. This is because there is less tendency for the liquid molecules to associate with the surface than with themselves. In other words, it is thermodynamically less favorable. In comparison, if a drop of liquid wets the surface well, Figure II, it means that there is a more thermodynamically favorable interaction between the molecules of the liquid and the surface than there is between the liquid molecules themselves.

Good wetting is a necessary but not sufficient condition for good adhesion. Even if a coating or adhesive wets well, it does not necessarily mean that it will bond well. If a liquid (paint, adhesive, or prepolymer) doesn't tend to associate with a (wet) surface, it almost certainly will not bond well.

Most prepolymers, coatings, paints, and adhesive have relatively high surface tension. This is primarily because of hydrogen bond intermolecular attractions between heteroatom (oxygen and nitrogen) functionalities. This is illustrated in Figure III. This means that in order to get wetting and subsequent adhesion, the surface needs to be fairly high energy. But since most plastic and rubber surfaces are low surface energy, good adhesion cannot be achieved.

Since many plastics and polymers are based on cross-linked resins, their surfaces are smooth and shiny; this, however, makes for very poor adhesion. In the following paragraph Dr. Bauman explains the effect surface modification has on cross linked materials. The core of the present invention also relies on cross linked resins to provide mechanical strength and help achieve the desired physical properties needed and the transportation and recreational vehicle applications herein discussed.

In order to enable polar liquids (water, prepolymer, etc), which have high surface tension, to wet plastic and rubber, the surface needs to be made ‘high energy’. This can be done with surface-modification. The term surface-modification. in its most general form, refers to any process that changes a surface. This could include cleaning, sanding, priming, or chemically-modifying the molecular structure of the surface.

In this paper, surface-modification refers to the chemical modification of a surface by exposure to a highly reactive gas atmosphere. In all of the examples for this paper, the surface-modifications are performed with a controlled oxidation. Our reactive gas treatments generally include fluorine (F₂), oxygen (O₂), and other gases. One of the types of reactions that are believed to occur is depicted in Figure IV. This chemistry results in creation of hydroxyl, carboxyl, and other very polar functional groups on the surface.

Also, the chemistry of this reactive gas process is such that crosslinking of the surface molecules occurs at the same time, Figure V. This is important because it renders the treatments permanent by inhibiting molecular rotations that normally occur to bury polar groups. (This is to minimize interfacial energy with air.) Thus, treated parts can be painted, adhered, or cast upon even years after treatment and still provide excellent adhesion.)

The second reason that most rubber and plastic surfaces cannot be bonded to very well is the fact that these materials have ‘inert’ surfaces, which cannot react or participate as the paint, coating, adhesive or PU cures.

The functional groups formed by surface-modifications, Figure IV, enable paints, coatings, and adhesives to bond to the surface during cure. The chemistry could involve formation of formal chemical bonds or simply formation of numerous hydrogen bonds.

It is important to note that different treatments are required for different substrates. The reactive gas processes are actually a form of controlled oxidation. Different types of rubber and plastic have widely different susceptibilities to oxidation. Furthermore, additives commonly used also have a profound effect on reactivity. For example, many rubber and plastics contain antioxidants and antiozonants for the purpose of protecting against oxidation. Obviously the treatment conditions need to be such that the inhibiting effects are overcome. But at the same time, one cannot use overly aggressive conditions or the part being treated can catch fire. Treating materials with high surface to volume ratio, such as fine fibers, thin film, or foam, requires special finesse.

One of the advantages of the present invention is the ability to provide strength when the product is put into sheer. The following table provided by Fluoro-Seal shows what happens when an Olefin is tested for sheer strength in an untreated application, followed by the results of the same test after the product was surface modified using the fluoro-seal process.

### SUMMARY

It is the unique combination of polymer materials, forming techniques and surface modification processes that give the present invention its ability to provide the needed strength, physical properties, durability, and light weight to be an economical and practical answer for core material needed in the transportation industry.

### SUMMARY OF THE INVENTION

The present invention is an improvement of the core material that can be made on the equipment and method described in the Background.

By using a ThermoPlastic Olefin/Thermo Plastic Vulcanite olefinic hybrid material, a new core material is revealed. The use of this resin and input sheet produce a novel core product. Unlike high impact polystyrene and ABS that becomes very brittle as their temperatures fall, the present invention continued to maintain its physical properties to temperatures down to −30° F. Then the loss of physical properties is much less than other plastic materials (See Table 1.)

The key, like many modern polymers, is the correct application of input materials. The present invention matches the end use and input resin and process to form input sheet and formed core from core to a variety of uses.

The core of the present invention can be surface modified to promote adhesion, if desired. Olefinic TPEs (Thermoplastic elastomers) and TPOs (thermoplastic olefins) and TPVs (Thermoplastic Vulcanites) are highly engineered resins to have a very wide range of physical properties.

The flexural modulus can be over 300,000 psi. These resins also provide elasticity or the ability to flex or bend at room temperatures. They can be formed at lower process temperatures than polycarbonates and acrylics.

Even though TPOs process at lower temperatures, they will hold shape and the ability to serve the intended purpose in the finished product at ambient temperatures 169° F. to 200° F. with no modification.

The transportation industry normally requires material with “class B” fire rating. The present invention is made from resins rated HB in the UL test. With additives the resin can meet UL 94 V-O if required to. When the core and faces or skins of 94 HB or V-O rating are laminated, then the finished product can meet the V-O fire rating.

TABLE I

| | | | | | TPO alloy of |
|---|---|---|---|---|---|
| | | | | | the present |
| Test | Material | HIPS | ABS | PC | invention |
| ASTMD- 790 | ½″ core | 654 | 785 | 1,751 | 10,000 |
| Flexural | | | | | |
| Strength psi | | | | | |
| ASTMC- 365 | ½″ core | 754 | 935 | 1,000 | 4,200 |
| Compressive | | | | | |
| Strength psi | | | | | |
| ASTMC- 393 Shear | ½″ core | 132 | 215 | 431 | 1,250 |
| Strength psi | | | | | |
| ASTMC- 364-61 | 1″ core | 167 psi | — | 199 psi | 2,800 psi |
| Edgewise | | | | | |
| Compressive | | | | | |
| Strength psi | | | | | |

TABLE II
Typical Properties of TPO in Put Resin

| | | | Typical |
|---|---|---|---|
| Property | Method | Units | Value |
| Specific Gravity | D792 | | 0.896 |
| Hardness, Shore D 0 sec/5 sec | D2240 | Shore D | 60/57 |
| MFR, 2160 gm, 230 C. | D1238 | g/10′ | 10 |
| Flexural Strength | D790 | psi | 3500 |
| Tangent Flex Modulus | D790 | kpsi | 125 |
| Tensile Strength | D638 | psi | 3100 |
| Ultimate % elongation | D638 | % | 410 |
| Notched Izod Impact Strength, 23 C. | D256 | ft-lb/in | 11 |
| Notched Izod Impact Strength, −30 C. | D256 | ft-lb/in | 0.9 |
| Gardner Drop Impact, 23 C. | D3029 | in-lbf | 288 |
| Gardner Drop Impact, −30 C. | D3029 | in-lbf | 320 |
| HDT 66 psi | D648 | F | 199 |
| Tear Strength, 2 ipm | D624 | pli | 875 |
| % Tensile Strength retained 121 C./7 D | D638 | % | 90 |
| % elongation retained 121 C./7 D | D638 | % | 90 |

### BRIEF DESCRIPTION OF DIGITAL PHOTOGRAPHS AND DRAWINGS

FIG. 1: Photo of present invention showing the triangle shape (truss) from the top surface.

FIG. 2: Photo of old-style honeycomb core made by stretching (pulling) a sheet of ABS.

FIG. 3: Side or end view showing true-triangle shape of core made of TPO.

FIG. 4: Side or end view of a core that has been pulled beyond limits of the ABS. Notice the cells have deformed. This core is weaker than core of the present invention.

FIG. 5: Drawing of forming elements for truss shape in top and bottom of core.

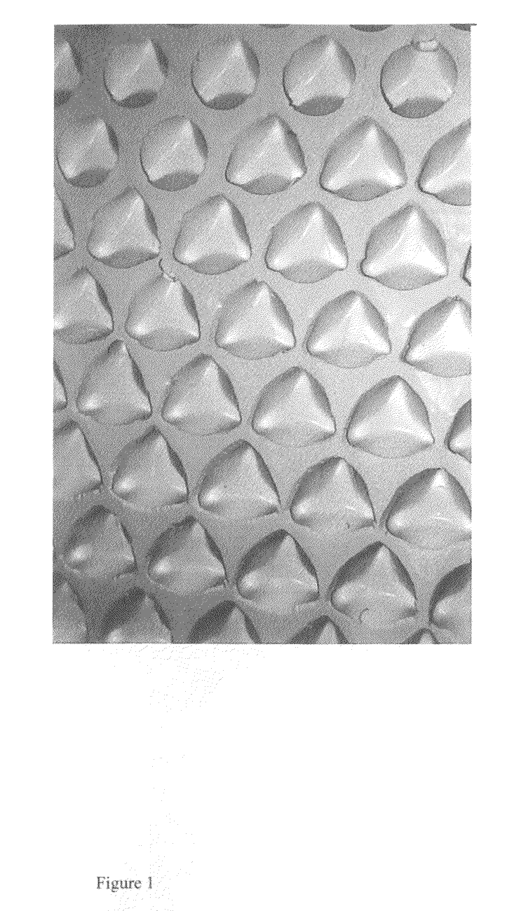

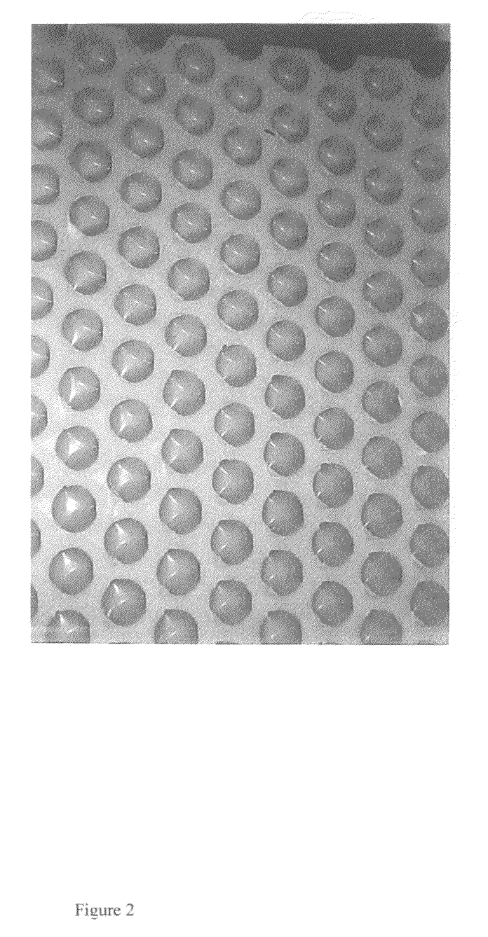

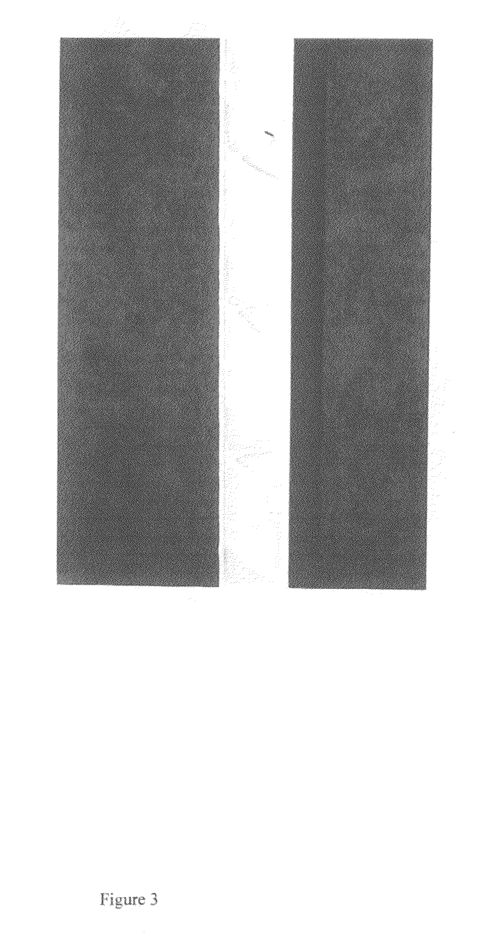

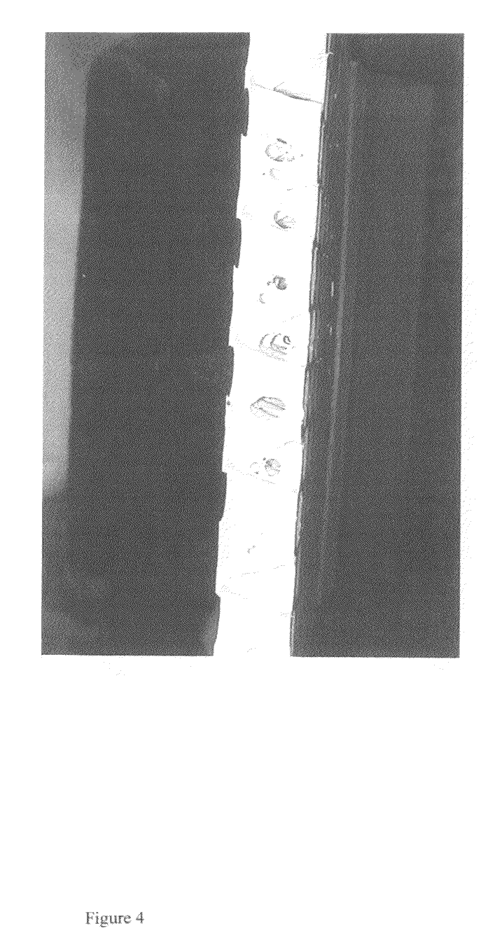

What is claimed:

1. The present invention is a three-dimensional core product, made of thermoformable material, preferably a TPO, or olefinic material, but may include other more common plastics, such as HIPS (High Impact Poly Styrene), Acrylics, and Polycarbonates. These Materials lend themselves to lamination using common adhesives such as Acrylics, Epoxies, Urethanes, Elastomers, and Nano-Adhesives.

2. The present invention is formed from flat stock by, but not limited, to the following: Thermoforming, Roll Forming, Pressure Forming, or Stretch Forming.

3. The present invention may be surface modified, to improve adhesion in the lamination process by, but not limited to, exposure to highly reactive gas such as fluorine, coated with a Prep Solution or be Mechanically Abraded.
